(19) United States
(12) Patent Application Publication
(10) Pub. No.: US 2012/0301783 A1
(43) Pub. Date: Nov. 29, 2012

(54) NEGATIVE ELECTRODE FOR NON-AQUEOUS ELECTROLYTE SECONDARY BATTERY AND NON-AQUEOUS ELECTROLYTE SECONDARY BATTERY

(76) Inventor: Takashi Shimada, Osaka (JP)

(21) Appl. No.: 13/576,120

(22) PCT Filed: Jan. 13, 2011
(86) PCT No.: PCT/JP2011/000142

§ 371 Date: Jul. 30, 2012

(30) Foreign Application Priority Data
Jan. 29, 2010 (JP) 2010-018164

(51) Int. Cl. H01M 4/64; B05D 5/12

(52) U.S. Cl. 429/211; 427/78

(57) ABSTRACT

Disclosed is a non-aqueous electrolyte secondary battery including a positive electrode absorbing and releasing lithium ions, a negative electrode, a porous insulating layer interposed between the positive electrode and the negative electrode, and a non-aqueous electrolyte with lithium ion conductivity. The negative electrode includes a current collector having a plurality of protrusions on a surface thereof, and particulate bodies being respectively supported on the protrusions, and including an alloy-type active material. The negative electrode has gaps between the particulate bodies adjacent to each other. The particulate bodies extend outwardly from surfaces of the protrusions of the current collector, and are each an aggregate of a plurality of clusters including the alloy-type active material.

### TECHNICAL FIELD

The present invention relates to a negative electrode for a non-aqueous electrolyte secondary battery, and a non-aqueous electrolyte secondary battery. Specifically, the present invention relates to an improvement of a negative electrode for a non-aqueous electrolyte secondary battery including an alloy-type active material as a negative electrode active material.

### BACKGROUND ART

Non-aqueous electrolyte secondary batteries, because of their high capacity and high energy density, are widely used as power sources for various electronic devices. A typical negative electrode active material used for currently commercially available non-aqueous electrolyte secondary batteries is graphite reversibly absorbing and releasing lithium ions. The theoretical capacity density of graphite is 372 mAh/g. However, with improvement in performance and increase in function of electronic devices, there is a demand for a higher capacity of non-aqueous electrolyte secondary batteries.

The negative electrode active material for non-aqueous electrolyte secondary batteries are required, for example: to have a small molecular weight so that a large amount of lithium ions can be absorbed therein; to allow lithium ions to be easily diffused in its interior; to be chemically stable and inexpensive; to be easily synthesized; and to be excellent in cycle characteristics.

In order to achieve a higher capacity of non-aqueous electrolyte secondary batteries, it is effective to use a negative electrode active material having a capacity larger than graphite. A material attracting attention as such a negative electrode active material is an alloy-type active material containing, for example, silicon or tin. Silicon reacts with lithium to form a compound represented by the formula: Li_{4.4}Si(Li₂₂Si₅), and has a theoretical capacity density of about 4000 mAh/g. Tin reacts with lithium to form a compound represented by the formula: Li_{4.4}Sn(Li₂₂Sn₅), and has a theoretical capacity density of about 1000 mAh/g.

An alloy-type active material, however, greatly expands and contracts when absorbing and releasing lithium ions therein and therefrom, to generate a large stress. This causes warpage or cut in the negative electrode current collector, deforming the negative electrode. Consequently, the negative electrode and the separator become locally spaced apart from each other, and the distance between the negative electrode and the positive electrode varies. As a result, the charge/discharge reaction proceeds unevenly in the battery, and thus, the battery characteristics such as the battery capacity and cycle characteristics tend to deteriorate.

With regard to a negative electrode for a non-aqueous electrolyte secondary battery including an alloy-type active material as a negative electrode active material, one proposal suggests a negative electrode obtained by depositing a silicon thin film on a current collector having protrusions and recesses on its surface, in which a plurality of gaps are formed in the silicon thin film (see Patent Literature 1). Another proposal suggests a negative electrode including: a current collector having an average surface roughness Ra of 0.01 to 1 μm; and a plurality of columnar crystal grains comprising silicon, and growing from a surface of the current collector in the direction inclined against the direction perpendicular to the surface (see Patent Literature 2).

### CITATION LIST

### Patent Literature

### [PTL 1] Japanese Laid-Open Patent Publication No. 2002-313319

### [PTL 2] Japanese Laid-Open Patent Publication No. 2005-196970

### SUMMARY OF INVENTION

### Technical Problem

According to the technique of Patent Literature 1, the size of the gaps formed in the silicon thin film cannot be controlled, and thus, the size of the gaps tends to vary. As a result, the stress generated due to expansion and contraction of the alloy-type active material cannot be sufficiently absorbed at the portion where the size of the gaps is small.

According to the technique of Patent Literature 2, gaps are formed around the roots of the columnar crystal grains, whereas near the tips of the columnar crystal grains, two or more columnar crystal grains are in contact with each other. As such, the stress absorption is not sufficiently relieved by the gaps. Although this technique is effective to some extent in suppressing the deformation of the negative electrode and the separation of the columnar crystal grain from the current collector during charge and discharge, for the reason as describe above, it is impossible to sufficiently suppress the deterioration in cycle characteristics of the battery.

The present invention intends to provide a non-aqueous electrolyte secondary battery including a negative electrode which includes an alloy-type active material as a negative electrode active material, and having excellent cycle characteristics.

### Solution to Problem

One aspect of the present invention is a negative electrode for a non-aqueous electrolyte secondary battery, including: a current collector having a plurality of protrusions on a surface thereof; and particulate bodies being respectively supported on the protrusions, and including an alloy-type active material. The negative electrode has gaps between the particulate bodies adjacent to each other. The particulate bodies extend outwardly from the surfaces of the protrusions of the current collector, and each comprise an aggregate of a plurality of clusters including the alloy-type active material.

Another aspect of the present invention is a non-aqueous electrolyte secondary battery including a positive electrode absorbing and releasing lithium, the above negative electrode for a non-aqueous electrolyte secondary battery, a porous insulating layer interposed between the positive electrode and the negative electrode, and a non-aqueous electrolyte with lithium ion conductivity.

### Advantageous Effects of Invention

According to the present invention, it is possible to provide a non-aqueous electrolyte secondary battery having a small capacity reduction even after repeated charge and discharge.

While the novel features of the invention are set forth particularly in the appended claims, the invention, both as to organization and content, will be better understood and appreciated, along with other objects and features thereof, from the following detailed description taken in conjunction with the drawings.

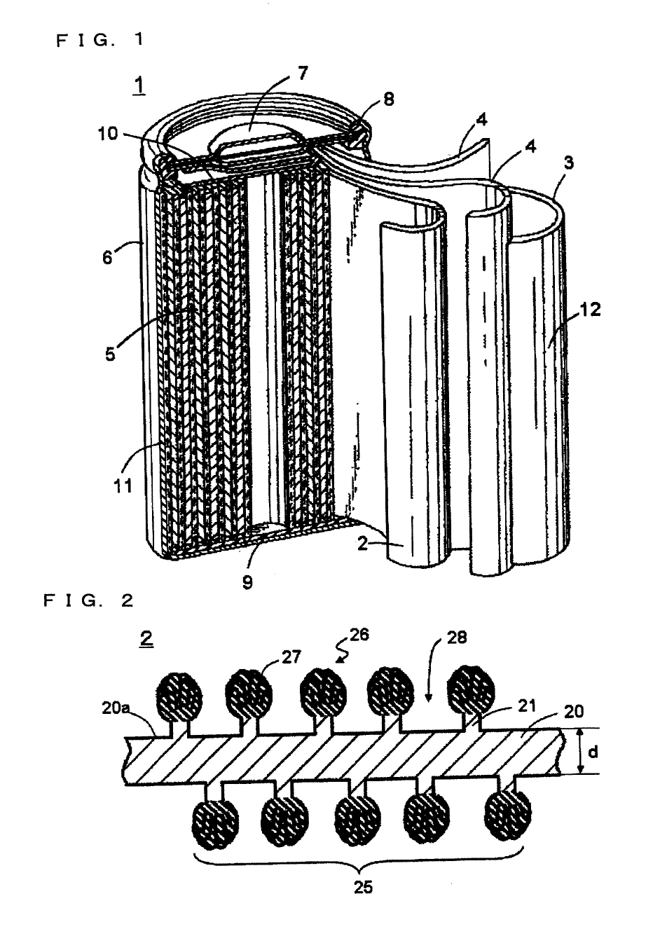

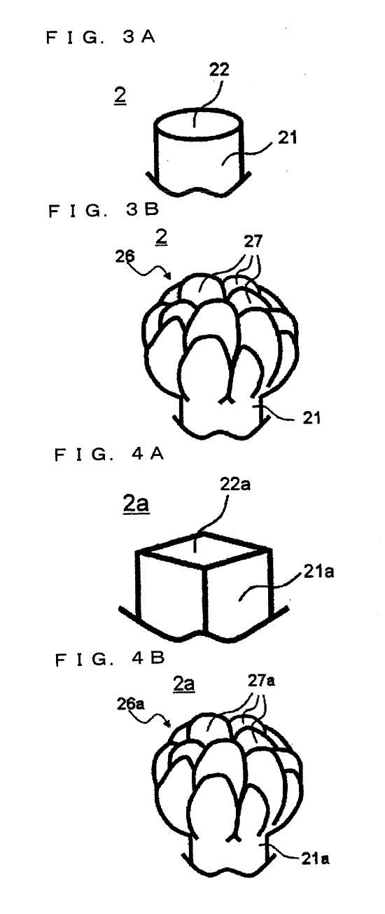

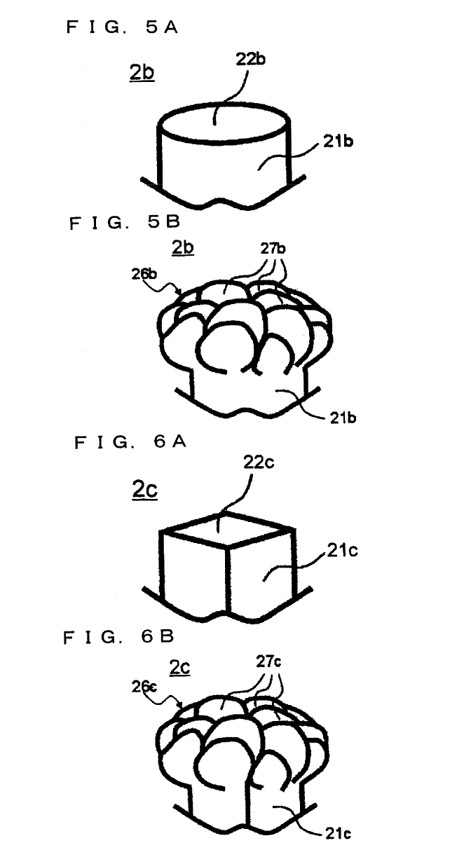

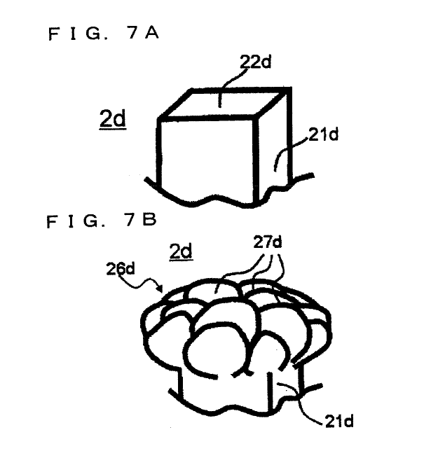

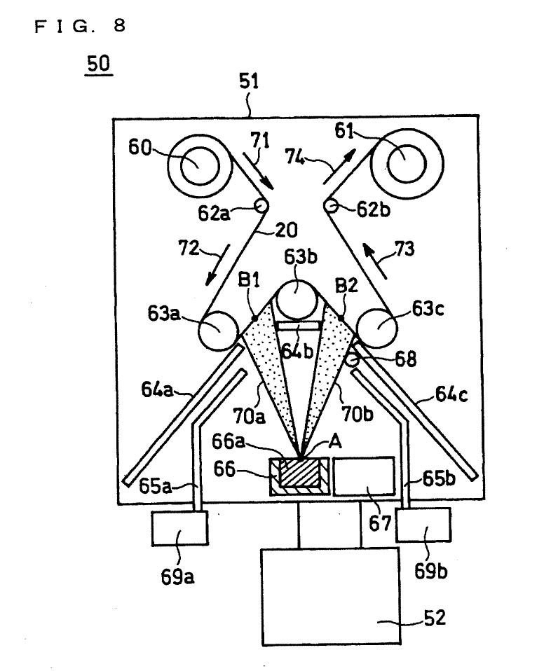

### BRIEF DESCRIPTION OF DRAWINGS

[FIG. 1] partially cut-away oblique view schematically showing a configuration of a non-aqueous electrolyte secondary battery according to one embodiment of the present invention.

[FIG. 2] A cross-sectional view schematically showing a configuration of a negative electrode for the non-aqueous electrolyte secondary battery according to one embodiment of the present invention.

[FIG. 3A] An oblique view schematically showing a configuration of a protrusion in the negative electrode for a non-aqueous electrolyte secondary battery shown in FIG. 2.

[FIG. 3B] An oblique view schematically showing a configuration of a particulate body formed on the surface of the protrusion in the negative electrode for a non-aqueous electrolyte secondary battery shown in FIG. 2.

[FIG. 4A] An oblique view schematically showing a configuration of a protrusion in a negative electrode of Example 2.

[FIG. 4B] An oblique view schematically showing a configuration of a silicon oxide particulate body in the negative electrode of Example 2.

[FIG. 5A] An oblique view schematically showing a configuration of a protrusion in a negative electrode of Example 3.

[FIG. 5B] An oblique view schematically showing a configuration of a silicon oxide particulate body in the negative electrode of Example 3.

[FIG. 6A] An oblique view schematically showing a configuration of a protrusion of a negative electrode of Example 4.

[FIG. 6B] An oblique view schematically showing a configuration of a silicon oxide particulate body in the negative electrode of Example 4.

[FIG. 7A] An oblique view schematically showing a configuration of a protrusion in a negative electrode of Example 5.

[FIG. 7B] An oblique view schematically showing a configuration of a silicon oxide particulate body in the negative electrode of Example 5.

[FIG. 8] A side view schematically showing a configuration of an electron beam vacuum vapor deposition apparatus.

### DESCRIPTION OF EMBODIMENT

A negative electrode for a non-aqueous electrolyte secondary battery of the present invention (hereinafter simply referred to as a “negative electrode”) includes a current collector and a plurality of particulate bodies including an alloy-type active material, the current collector and the particulate bodies having features as described below.

The current collector has a plurality of protrusions on a surface thereof. Specifically, the protrusions are formed with predetermined clearances therebetween on a surface of the current collector, and extend outwardly from the surface of the current collector. Preferably, the protrusions have a top surface substantially parallel to the surface of the current collector, and the top surface has minute roughness. Since the protrusions have such a top surface, particulate bodies formed of a plurality of clusters including an alloy-type active material as described below can be easily formed. The plane shape of the top surface is preferably circular, oval, regular square, rectangular, or rhomboid. This allows an easy formation of particulate bodies whose three-dimensional shape is spherical, spheroid, or egg-like.

One protrusion supports one particulate body. Such particulate bodies collectively constitute a negative electrode active material layer. There are gaps between the particulate bodies adjacent to each other. The gaps absorb the stress generated due to expansion and contraction of the particulate bodies, and this suppresses the separation of the particulate body from the protrusion and the deformation of the current collector and the negative electrode, and thus suppresses the deterioration in battery capacity and cycle characteristics.

The particulate bodies extend outwardly from the surfaces of the protrusions of the current collector, and each comprise an aggregate of a plurality of clusters including an alloy-type active material. As such, each cluster has, for example, a vertically long three-dimensional shape. Since the particulate body is divided into a plurality of clusters, the stress generated in each cluster in association with charge and discharge is reduced. As a result, the separation of the particulate body from the protrusion, and the deformation of the current collector and the negative electrode occurring in association with charge and discharge are remarkably suppressed.

The clusters preferably have a columnar or scale-like three-dimensional shape. When the clusters have a three-dimensional shape as above, the stress generated in association with charge and discharge is likely to be reduced. Further, the clusters included in one particulate body are preferably spaced apart from each other. By configuring as above, the stress between the clusters is further relieved.

The three-dimensional shape of the particulate bodies is preferably spherical, spheroid, or egg-like. This configuration allows the stress generated due to absorption of lithium ions to become uniform in the particulate body. Particularly at the interface between the particulate body and the protrusion, the stress becomes uniform in terms of magnitude and direction. This can more effectively suppress the separation of the particulate body from the protrusion. In addition, when the particulate bodies have a three-dimensional shape as above, the area of the particulate bodies facing the positive electrode active material layer via a porous insulating layer is increased. This can favorably influence the battery characteristics such as the battery capacity and cycle characteristics. The alloy-type active material is preferably at least one selected from the group consisting of a silicon-based active material, and a tin-based active material.

According to the present invention, by forming a plurality of protrusions with predetermined clearances therebetween on the surface of the current collector, and forming one particulate body on the surface of one protrusion, the three-dimensional shape of the particulate bodies can be easily controlled. This makes it possible to provide comparatively large gaps between the particulate bodies adjacent to each other. The gaps significantly reduce the internal stress associated with the expansion of an alloy-type active material when lithium ions are absorbed in the alloy-type active material through the battery reaction. As a result, separation or exfoliation of the particulate body from the surface of the protrusion can be suppressed.

A non-aqueous electrolyte secondary battery of the present invention includes a positive electrode absorbing and releasing lithium, the above-described negative electrode, a porous insulating layer interposed between the positive electrode and the negative electrode, and a non-aqueous electrolyte with lithium ion conductivity. The non-aqueous electrolyte secondary battery of the present invention, because of the inclusion of the above-described negative electrode, has a high capacity and a high energy density, in which the deterioration in battery characteristics such as cycle characteristics is remarkably suppressed.

In the following, the negative electrode for a non-aqueous electrolyte secondary battery, and the non-aqueous electrolyte secondary battery of the present invention are more specifically described. FIG. 1 is a partially cut-away oblique view schematically showing a configuration of a non-aqueous electrolyte secondary battery 1 according to one embodiment of the present invention. FIG. 2 is a cross-sectional view schematically showing a configuration of a negative electrode 2 included in the battery 1. FIG. 3A is an oblique view schematically showing a configuration of a protrusion 21 of the negative electrode 2. FIG. 3B is an oblique view schematically showing a configuration of a particulate body 26 in the negative electrode 2.

The battery 1 includes an electrode group 5 obtained by spirally winding the negative electrode 2 and a positive electrode 3 with a porous insulating layer 4 interposed therebetween. The electrode group 5 is accommodated, together with a non-aqueous electrolyte, in a bottomed cylindrical battery case 6 with one end thereof in the longitudinal direction being open. The opening of the battery case 6 is sealed by a sealing plate 7. A gasket 8 is interposed between the battery case 6 and the sealing plate 7, to insulate the battery case 6 from the sealing plate 7. A negative-side insulating plate 9 is disposed at one end of the electrode group 5 in the longitudinal direction thereof, to insulate the electrode group 5 from the battery case 6. A positive-side insulating plate 10 is disposed at the other end of the electrode group 5 in the longitudinal direction thereof, to insulate the electrode group 5 from the sealing plate 7. The battery 1 further includes a negative electrode lead 11 for electrically connecting the negative electrode 2 to the battery case 6, and a positive electrode lead 12 for electrically connecting the positive electrode 3 to the sealing plate 7. The battery 1 is characterized by including the negative electrode 2, and is configured similarly to the conventional lithium ion secondary battery, except the inclusion of the negative electrode 2.

The negative electrode 2 includes, as shown in FIG. 2, a current collector 20 having a plurality of protrusions 21 on surfaces 20a on both sides thereof, and an active material layer 25 comprising a plurality of particulate bodies 26 being respectively supported on the protrusions 21.

The protrusions 21 extend outwardly from the surfaces 20a of the current collector 20. Although the protrusions 21 are formed on the surfaces 20a on both sides of the current collector 20 in this embodiment, the protrusions 21 may be formed on one of the surfaces 20a of the current collector 20. A thickness d of a portion of the current collector 20 where the protrusions 21 are not formed (hereinafter simply referred to as a “thickness d of the current collector 20”) is preferably 5 μm to 30 μm.

The protrusions 21 on the surface 20a of the current collector 20 are preferably arranged in a regular pattern, such as a grid pattern, a staggered pattern, or a closest-packed pattern. By configuring as above, the stress applied to the current collector 20 in association with absorption of lithium ions into the particulate bodies 26 becomes nearly uniform throughout the current collector 20, which makes it possible to suppress a local deformation of the current collector 20 and the like. The clearance between the protrusions 21 adjacent to each other is preferably 10 μm to 100 μm, and more preferably 40 μm to 80 μm, in view of providing gaps 28 which are large enough to absorb the stress generated due to expansion of the particulate bodies 26.

The height of the protrusions 21 is preferably 30 μm or less, and more preferably 3 μm to 20 μm, in view of the mechanical strength of the protrusions 21. The width of the protrusions 21 is preferably 1 μm or more, and more preferably 5 μm to 40 μm, also in view of the mechanical strength of the protrusions 21. The height and width of the protrusions 21 are, respectively, defined on a cross section of the current collector 20 in the thickness direction thereof, as a length of a perpendicular from the tip end of the protrusion 21 to the surface 20a of the current collector 20, and a maximum length of the protrusion 20 in the direction parallel to the surface 20a of the current collector 20. The height and width of the protrusions 21 can be determined by observing a cross section of the negative electrode 2 under, for example, a scanning electron microscope, or a laser microscope.

The protrusions 21 have a top surface 22 substantially parallel to the surface 20a of the current collector 20. The area of the top surface 22 is not particularly limited, and is preferably 200 μm² or less, more preferably 1 μm² to 1200 μm², and furthermore preferably 20 μm² to 400 μm², in view of suppressing a deformation of the negative electrode 2 due to expansion stress of the particulate bodies 26 supported on the protrusions 21. The top surface 22 preferably has minute roughness. The minute roughness measured as a ten-point average roughness Rz is preferably within a range from 0.1 μm to 5 μm. By configuring as above, the particulate bodies 26 each being an aggregate of a plurality of clusters 27 spaced apart from each other can be easily formed.

Although the plane shape of the top surface 22 is circular in this embodiment, it is not particularly limited thereto. Other than this, the plane shape of the top surface 22 may be oval, regular square, rectangular, or rhomboid. By selecting the plane shape of the top surface 22, the three-dimensional shape of the particulate body 26 can be changed. For example, in the case where the plane shape of the top surface 22 is circular or regular square, the particulate body 26 formed thereon has a spherical or spindle-like shape. In this case, when the particulate bodies 26 absorb lithium ions, the magnitudes of the stress generated inside the particulate body 26 become equal, and the directions in which the stress is applied become the same. In addition, the stress generated at the interface between the particulate body 26 and the protrusion 21 is less varied. As a result, separation of the particulate body 26 from the protrusion 21 can be further suppressed.

In the case where the plane shape of the top surface 22 is rectangular, rhomboid, or oval, the particulate body 26 formed thereon has a unidirectionally long spherical shape, i.e., a spheroid, egg-like, or dome-like shape. In other words, the particulate body 26 formed thereon has a narrow spherical shape having a long-side direction and a short-side direction. In the short-side direction of the particulate bodies 26, the gaps 28 between the adjacent particulate bodies 26 are large. As a result, the gaps 28 can more effectively reduce the internal stress generated when the particulate bodies 26 absorb lithium ions, and thus, the separation of the particulate body 26 from the protrusion 21 can be further suppressed. The plane shape of the top surface 22 is defined as a shape of the protrusion 21 on an orthographic projection of the current collector 20 as viewed from vertically above.

The current collector 20 having the protrusions 21 can be formed by, for example, a resist method, or a press method. According to a resist method, a metal foil with a resist film formed at a predetermined position on its surface (i.e., a portion where the protrusions 21 are not to be formed) is subjected to plating treatment to form the protrusions 21, and then the resist film is removed, whereby the current collector 20 is obtained. According to a press method, a metal foil is press-molded using rollers whose surface has recesses corresponding to the protrusions 21 to be obtained in terms of the shape, size and arrangement, to plastically deform the metal foil locally, whereby the current collector 20 having the protrusions 21 on its surface is obtained.

The metal foil used in these methods may be, for example, a copper foil, a copper alloy foil, a stainless steel foil, or a nickel foil, the foil having a thickness of about 10 μm to 40 μm. A surface roughening treatment may be applied to either of the metal foil before forming the protrusions 21 thereon and the current collector 20 after forming the protrusions 21 thereon. The method of the surface roughening treatment is not particularly limited, and may be, for example, plating, etching, or blasting.

As shown in FIG. 3B, the particulate bodies 26 supported on the protrusions 21 are each an aggregate of the clusters 27 and each have, for example, a spherical three-dimensional shape. One protrusion 21 supports one particulate body 26. The particulate bodies 26 have almost the same three-dimensional shape. The gaps 28 are present between the particulate bodies 26 adjacent to each other. The clusters 27 constituting the particulate body 26 extend outwardly from the surfaces of the protrusions 21 of the current collector 20, and are spaced apart from each other. The cluster 27 is smaller in size than the particulate body 26, and is, for example, a cluster of alloy-type active material having a scale-like or columnar three-dimensional shape. In many cases, the cluster 27 has a vertically long three-dimensional shape.

As described above, the individual particulate bodies 26 are each formed as an aggregate of the scale-like or columnar clusters 27, and therefore, the stress generated in the individual clusters 27 can be reduced. In addition, the clusters 27 are spaced apart from each other, and therefore, the stress generated from the individual clusters 27 is further reduced. Furthermore, the gaps 28 are present around each columnar body 26. Because of these features, the stress of the particulate body 26 as a whole can be sufficiently reduced, and separation of the columnar body 26 from the protrusion 21 can be remarkably suppressed. As a result, it is possible to obtain a battery whose battery capacity and the like are maintained at the similar high level to that in the early stage of use, even after charge and discharge are repeated.

The dimensions of the particulate bodies 26 are not particularly limited, and are selected as appropriate according to, for example, the clearance between the adjacent protrusions 21, and the shape of the top surface 22 of the protrusions 21. For example, the particulate bodies 26, while not absorbing lithium ions, have a height of preferably 5 μm to 80 μm and more preferably 10 μm to 30 μm, and a width of preferably 5 μm to 80 μm and more preferably 10 μm to 30 μm. By selecting the dimensions of the particulate bodies 26 from the foregoing range, the effect obtained by forming the columnar bodies 26 as an aggregate of the clusters 27 becomes more remarkable.

The height and width of the particulate bodies 26 are, respectively, defined on a cross section of the negative electrode 2 in the thickness direction thereof, as a length of a perpendicular from the tip end of the particulate body 26 to the top surface 22 of the protrusion 21, and a maximum length of the particulate body 26 in the direction parallel to the surface 20a of the current collector 20. The height and width of the particulate bodies 26 can be determined by observing a cross section of the negative electrode 2 under, for example, a scanning electron microscope, or a laser microscope.

The number of the clusters 27 constituting one particulate body 26 may be different in every particulate body 26, and is preferably from 5 to 200. The number of the clusters 27 as used herein is an average number of the clusters 27 of ten particulate bodies 26. The dimensions of the clusters 27 are a height of about 0.1 μm to 20 μm, and a maximum width of about 0.1 μm to 10 μm. The adjacent clusters 27 are preferably spaced apart from each other by 100 nm to 1 μm.

The alloy-type active material constituting the clusters 27 is a material that absorbs lithium ions by alloying with lithium, and reversibly absorbs and desorbs lithium ions at a negative electrode potential. The alloy-type active material may be any known alloy-type active material without particular limitation, and is preferably a silicon-based active material and a tin-based active material, and more preferably a silicon-based active material.

Examples of the silicon-based active material include, without particular limitation, silicon, a silicon compound, and a silicon alloy. The silicon compound is exemplified by a silicon oxide represented by the formula: SiOₐ where 0.05<a<1.95, a silicon carbide represented by the formula: SiC_{b} where 0<b<1, and a silicon nitride represented by the formula: SiN_{c} where 0<c<4/3. The silicon alloy is exemplified by an alloy of silicon and another element X. Another element X is at least one element selected from the group consisting of Fe, Co, Sb, Hi, Pb, Ni, Cu, Zn, Ge, In, Sn and Ti.

Examples of the tin-based active material include tin, a tin compound, and a tin alloy. The tin compound is exemplified by a tin oxide represented by the formula: SnO_{d} where 0<d<2, tin dioxide (SnO₂), SnSiO₃, and a tin nitride. The tin alloy is exemplified by an alloy of tin and another element Y. Another element Y is at least one element selected from the group consisting of Ni, Mg, Fe, Cu and Ti. Typical examples of such an alloy are, for example, Ni₂Sn₄ and Mg₂Sn.

The active material layer 25 comprising the particulate bodies 26 can be formed on the surfaces of the protrusions 21 of the current collector 20 by, for example, a vapor phase method or a sintering method. Examples of the vapor phase method include vacuum vapor deposition, sputtering, ion plating, laser ablation, chemical vapor deposition, plasma chemical vapor deposition, and flame spraying. Among these methods, a vapor phase method is preferable, and vacuum vapor deposition is particularly preferable.

In the case of forming the particulate bodies 26 each being an aggregate of the clusters 27 spaced apart from each other by vacuum vapor deposition, the degree of vacuum in the vacuum chamber and the distance from the target to the current collector in a vacuum vapor deposition apparatus are to be controlled. The degree of vacuum is dependent on, for example, the size of the vacuum chamber, and the gas flow rate from the gas supply nozzle disposed in the vacuum chamber, and is set, during vapor deposition, preferably within a range from 5×10⁻⁴ Pa to 5×10⁻¹ Pa, and more preferably within a range from 1×10⁻³ Pa to 1×10⁻² Pa. The distance from the target to the current collector is a distance from the center of the upper end plane of the target to the center of the current collector 20 which is passing through a vapor deposition zone defined by shielding plates. The distance from the target to the current collector is set preferably within a range from 10 cm to 500 cm, and more preferably within a range from 20 cm to 200 cm.

The center of the upper end plane of the target is dependent on the plane shape of the upper end plane, and when the shape of the upper end plane is, for example, a circle, the center of the target is the center of the circle. When the shape of the upper end plane of the target is, for example, a polygon having four or more sides, the center of the target is the point of intersection of the diagonals. When the shape of the upper end plane of the target is, for example, an ellipsoid (e.g., a shape obtained by replacing two short sides of a rectangle with arc-shaped segments), the center of the target is the point of intersection of the diagonals of the smallest rectangular circumscribing the ellipsoid. The center of the current collector 20 is the center of a portion of the current collector 20 exposed in the vapor deposition zone (hereinafter referred to as a “vapor deposition portion”). The vapor deposition portion usually has a square plane shape, and the center thereof is the point of intersection of the diagonals. The square of this embodiment includes not only a regular square and a rectangular but also, for example, a parallelogram, a rhomboid, and a trapezoid.

The particulate bodies 26 each being an aggregate of the clusters 27 spaced apart from each other can be easily formed by selecting the degree of vacuum in the vacuum chamber and the distance from the target to the current collector during vapor deposition, from the foregoing range. If at least one of the degree of vacuum in the vacuum chamber and the distance from the target to the current collector during vapor deposition falls outside the foregoing range, solid columnar bodies each formed of a plurality of thin films stacked in the thickness direction may be formed.

FIG. 8 is a side view schematically showing a configuration of an electron beam vacuum vapor deposition apparatus 50 (hereinafter simply referred to as a “vapor deposition apparatus 50”). In FIG. 8, the members inside the vapor deposition apparatus 50 are shown by a solid line. The vapor deposition apparatus 50 is equipped with a vacuum chamber 51, and a vacuum pump 52 for evacuating the vacuum chamber 51. Disposed in the vacuum chamber 50 are rollers for transferring the current collector 20 within the vacuum chamber 50: a supply roller 60; a take-up roller 61; guide rollers 62a and 62b; and cooling rollers 63a, 63b and 63c. Further disposed are: shielding plates 64a, 64b and 64c for allowing silicon or a silicon oxide to vapor deposit on the surface of the current collector 20 at a predetermined position while being transferred; oxygen nozzles 65a and 65b; an evaporation crucible 66 being a target for accommodating a silicon raw material 66a; and an electron beam generator 67. A film thickness meter 68 is further disposed inside the vacuum chamber 50, and senses the thickness of the active material layer 25 (the height of the particulate bodies 26) formed on the surface of the current collector 20.

Around the supply roller 60, the strip-like current collector 20 is wound. The guide roller 62a guides the current collector 20 drawn from the supply roller 60 toward the cooling roller 63a, and the guide roller 62b guides the current collector 20 with a silicon-based active material vapor-deposited thereon toward the take-up roller 61. The take-up roller 61 collects the current collector 20 on which a silicon-based active material has been vapor deposited.

The cooling rollers 63a, 63b and 63c are each equipped with a cooling device (not shown) in its interior, and cool the current collector 20. By supplying silicon vapor or a mixture of silicon vapor and oxygen to the cooled current collector 20, a silicon-based active material comprising silicon or a silicon oxide is deposited on the surfaces of the protrusions 21 of the current collector 20.

The shielding plates 64a, 64b and 64c define the zone where silicon vapor or a mixture of silicon vapor and oxygen is supplied to the current collector 20. A zone formed by the shielding plates 64a and 64b is a first vapor deposition zone 70a, and a zone formed by the shielding plates 64b and 64c is a second vapor deposition zone 70b. In the first and second vapor deposition zones 70a and 70b, silicon vapor or a mixture of silicon vapor and oxygen is supplied to the surface of the current collector 20. The distances from the center point A of the upper end plane of the evaporation crucible 66 to the center point El of the current collector 20 in the first vapor deposition zone 70a, and to the center point B2 of the current collector 20 in the second vapor deposition zone 70b are set to, for example, 20 cm to 200 cm.

Oxygen nozzles 65a and 65b are connected to an oxygen cylinder (not shown) via oxygen flow regulators 69a and 69b disposed outside the vacuum chamber 51, respectively, and supply oxygen into the vacuum chamber 51. The oxygen nozzles 65a and 65b, the oxygen flow regulators 69a and 69b, and the oxygen cylinder are connected to each other through a pipe (not shown). By supplying oxygen from the oxygen nozzles 65a and 65b, a mixture of silicon vapor and oxygen is supplied to the surface 20a of the current collector 20. In the case of not supplying oxygen, silicon vapor is supplied to the surface 20a of the current collector 20.

The vapor deposition apparatus 50 operates as follows. As a preparation, the supply roller 60 around which the current collector 20 is wound is set at a predetermined position, and the vacuum chamber 51 is evacuated by the vacuum pump 52. Upon evacuation of the vacuum chamber 51 to a predetermined degree of vacuum, the silicon raw material 66a placed in the evaporation crucible 66 is irradiated with an electron beam emitted from the electron beam generator 67, to generate silicon vapor. The amount of silicon vapor is controlled by feedbacking the thickness of the active material layer 25 (the height of the particulate bodies 26) sensed by the film thickness meter 68. At the same time, a predetermined amount of oxygen is supplied into the vacuum chamber 51 from the oxygen nozzles 65a and 65b.

In this state, the current collector 20 is allowed to pass along the cooling rollers 63a, 63b and 63c, during which the current collector 20 first reaches the first vapor deposition zone 70a, and then reaches the second vapor deposition zone 70b. In the first vapor deposition zone 70a, silicon vapor or a mixture of silicon vapor and oxygen is incident at an angle of 0° to 90° with respect to the direction perpendicular to the surface 20a of the current collector 20. In the second vapor deposition zone 70b, silicon vapor or a mixture of silicon vapor and oxygen is incident at an angle of −90° to 0° with respect to the direction perpendicular to the surface 20a of the current collector 20. The first vapor deposition zone 70a and the second vapor deposition zone 70b are line-symmetric to each other.

Since silicon vapor or a mixture of silicon vapor and oxygen is incident on the surface 20a of the current collector 20 at an oblique angle with respect to the direction perpendicular to the surface 20a of the current collector 20, a silicon-based active material can be easily deposited on the surfaces of the protrusions 21. On the other hand, silicon vapor or a mixture of silicon vapor and oxygen is difficult to reach a portion of the surface 20a where no protrusion 21 is formed, because it is shaded by the silicon-based active material deposited on the protrusions 21. As such, the amount of deposited silicon-based active material on the portion of the surface 20a where no protrusion 21 is formed is small as compared with that on the surfaces of the protrusions 21. The degree of vacuum in the vacuum chamber 51 during vapor deposition is set within a range from 1×10⁻³ Pa to 1×10⁻² Pa.

The silicon-based active material is thus deposited on the surfaces of the protrusions 21 of the current collector 20. The resultant current collector 20 is collected on the take-up roller 61. Thereafter, the transfer direction of the current collector 20 is reversed, and the current collector 20 is transferred from the take-up roller 61 toward the supply roller 60, to deposit the silicon-based active material on the protrusions 21 of the current collector 20. In this way, deposition of the silicon-based active material is repeated several times by reversing the transfer direction of the current collector 20, so that the particulate bodies 26 each being an aggregate of the clusters 27 are formed on the surfaces of the protrusions 21. The negative electrode 2 is thus obtained.

The positive electrode 3 includes, for example, a positive electrode current collector, and a positive electrode active material layer disposed on the surface of the positive electrode current collector. The positive electrode current collector may be a metal foil, such as aluminum, aluminum alloy, titanium, stainless steel, or nickel foil, having a thickness of about 10 μm to 30 μm. Although the positive electrode active material layer is formed on both surfaces of the positive electrode current collector in this embodiment, the positive electrode active material layer may be formed on one surface of the positive electrode current collector.

The positive electrode active material layer includes, for example, a positive electrode active material absorbing and releasing lithium ions, a conductive material, and a binder.

The positive electrode active material may be any material that absorbs and releases lithium ions, among which a lithium-containing metal composite oxide is preferable. A lithium-containing metal composite oxide is capable of generating a high voltage and has a high energy density, and therefore, is effective in achieving a higher capacity of the battery.

The lithium-containing metal composite oxide is exemplified by an oxide represented by the composition formula (1): Li₂MO₂, and an oxide represented by the composition formula (2): LiM₂O₄. In each formula, element M is at least one transition metal element. The transition metal element is not particularly limited, but preferably is cobalt, nickel and manganese, and particularly preferably is cobalt and nickel. The value Z representing the molar ratio of Li in the composition formula (1) varies within the range from 0.05 to 1.1 depending on the state of charge or discharge of the battery, and is within the range from 0.9 to 1.1 immediately after the lithium-containing metal composite oxide is produced. Examples of the lithium-containing metal composite oxide include LiCoO₂, LiNiO₂, and LiMn₂O₄. These positive electrode active materials may be used singly or in combination of two or more.

The conductive material and the binder may be any conventionally used conductive material and binder without particular limitation. Examples of the conductive material include carbon materials, such as carbon black and acetylene black. Examples of the binder include resin materials, such as polyvinylidene fluoride, and rubber materials.

The positive electrode active material layer can be formed by, for example, mixing a positive electrode active material, a conductive material and a binder with a dispersion medium, to prepare a positive electrode material mixture slurry, applying the positive electrode material mixture slurry onto a surface of a positive electrode current collector, and drying and rolling the applied film. The dispersion medium is not particularly limited, and exemplified by an organic solvent, such as N-methyl-2-pyrrolidone (NMP), and water.

The porous insulating layer 4 is interposed between the negative electrode 2 and the positive electrode 3 to provide insulation therebetween, and has lithium ion permeability. The porous insulating layer 4 may be, for example, a separator being a porous film made of a polyolefin such as polyethylene or polypropylene, or a metal oxide film composed of a metal oxide such as alumina and a binder for binding the metal oxide particles. A separator and a metal oxide film may be used in combination. The porous insulating layer 4 is impregnated with a liquid non-aqueous electrolyte.

The non-aqueous electrolyte may include, for example, a non-aqueous solvent, and a lithium salt dissolving in the non-aqueous solvent, and may include an additive, as needed.

Various organic solvents may be used as the non-aqueous solvent. Examples of the non-aqueous solvent include ethylene carbonate, propylene carbonate, dimethyl carbonate, diethyl carbonate, and ethyl methyl carbonate. These non-aqueous solvents may be used singly or in combination of two or more.

Various lithium salts may be used as the lithium salt. Examples of the lithium salt include LiPF₆, LiBF₄, LiCF₃SO₃, and LiClO₄. These lithium salts may be used singly or in combination of two or more. Examples of the additive include vinylene carbonate, vinylethylene carbonate, divinylethylene carbonate, cyclohexylbenzene, biphenyl, and diphenyl ether.

Although description is given of a wound electrode group in this embodiment, the electrode group included in the battery of the present invention may be a flat electrode group and a stacked electrode group. Although description is given of a cylindrical battery in this embodiment, the battery of the present invention may be of various forms, such as a prismatic battery, a thin battery, a laminate film pack battery, a coin battery, and a button battery.

### EXAMPLES

### Example 1

### (1) Production of Current Collector

A plurality of recesses was formed by laser machining on the surface of a forged steel roller (diameter: 50 mm, width: 100 mm, available from DAIDO MACHINERY, LTD.). The clearance between the recesses adjacent to each other was set to 60 μm. The shape of the opening of the recess was a circle of 20 μm in diameter. The depth of the recess was 10 μm. In such a manner, a roller for forming protrusions was prepared. Two rollers for forming protrusions were press-fitted, with the axes of the rollers aligned in parallel to each other, to form a nip portion.

A 30-μm-thick copper foil was passed through the nip portion, to be press-molded into a current collector 20 with a plurality of protrusions 21 formed on both surfaces thereof. The protrusions 21 had a top surface 22 in the shape of a circle of 10 μm in diameter, and a height of 5 μm. The clearance between the protrusions 21 adjacent to each other was 60 μm. The current collector 20 had a thickness d of 18 μm, and a length of 10 m.

### (2) Formation of Active Material Layer Composed of a Plurality of Silicon Oxide Particulate Bodies

Spherical particulate bodies 26 as shown in FIG. 3B supported on the protrusions 21 of the current collector 20 were formed using the vapor deposition apparatus 50 as shown in FIG. 8. The current collector 20 was wound around the supply roller 60 and set at a predetermined position in the vapor deposition apparatus 50. The distances from the center point A of the upper end plane of the evaporation crucible 66 to the center point B1 of the current collector 20 in the first vapor deposition zone 70a, and to the center point B2 of the current collector 20 in the second vapor deposition zone 70b were respectively set to 45 cm.

The evaporation crucible 66 and the shielding plates 64a, 64b and 64c were positioned such that: in the first vapor deposition zone 70a, a mixture of silicon vapor and oxygen, or silicon vapor is incident at an angle of 60° with respect to the direction perpendicular to a surface 20a of the current collector 20 passing therethrough; and in the second vapor deposition zone 70b, a mixture of silicon vapor and oxygen, or silicon vapor is incident at an angle of −80° with respect to the direction perpendicular to the surface 20a of the current collector 20 passing therethrough.

In the evaporation crucible 66, 200 g of silicon was placed. The vacuum chamber 51 was evacuated with the vacuum pump 52 until the degree of vacuum therein reached 3×10⁻⁴ Pa. Upon evacuation, while the degree of vacuum was maintained, the silicon placed in the evaporation crucible 66 was irradiated with an electron beam with an accelerating voltage of −10 kV emitted from the electron beam generator 67, to melt and vaporize the silicon and generate silicon vapor.

Next, oxygen was supplied from the oxygen nozzles 65a and 65b into the vacuum chamber 51. As this time, the tip end of the oxygen nozzle 65a was positioned such that the ejection direction of oxygen was approximately parallel to the current collector 20 passing through the first vapor deposition zone 70a. The tip end of the oxygen nozzle 65b was positioned such that the ejection direction of oxygen was approximately parallel to the current collector 20 passing through the second vapor deposition zone 70b. The flow rate of oxygen from the oxygen nozzles 65a and 65b were respectively regulated to 900 sccm using the oxygen flow regulators 69a and 69b. By introducing oxygen, the degree of vacuum in the vacuum chamber 51 during vapor deposition was set to 7.5×10⁻³ Pa.

Upon completion of these settings, in the vacuum chamber 51, the forward transfer of the current collector 20 from the supply roller 60 via the guide roller 62a along the cooling rollers 63a, 63b and 63c in the direction indicated by arrows 72 and 73 was carried out at a rate of 1.5 m/min, to vapor deposit a silicon oxide on the surface of the current collector 20, and the current collector 20 was collected on the take-up roller 61. Subsequently, the flow rate of oxygen from the oxygen nozzles 65a and 65b were respectively regulated to 810 sccm, and then, the reverse transfer of the current collector 20 from the take-up roller 61 via the guide roller 62b along the cooling rollers 63c, 63b and 63a was carried out at a rate of 1.5 m/min, to vapor deposit a silicon oxide on the current collector 20.

Thereafter, the forward transfer and the reverse transfer were repeated alternately in the same manner as above, except that the oxygen flow rate was sequentially changed to 720, 630, 540, 450, 360, 270, 180, 90 and 0 sccm, thereby to allow a silicon oxide or silicon to stack on one surface of the current collector 20. On the other surface of the current collector 20, vapor deposition was performed in the same manner as above. A negative electrode 2 was thus obtained. The obtained negative electrode 2 was observed under a scanning electron microscope, and the result found that a silicon oxide particulate body 26 was formed on the surface of each protrusion 21 of the current collector 20. The silicon oxide particulate body 26 was an aggregate of a plurality of scale-like clusters 27 as shown in FIG. 3B. The silicon oxide particulate body 26 had a spherical three-dimensional shape, and was 15 μm in height and 15 μm in width.

### Example 2

FIG. 4A is an oblique view schematically showing a configuration of a protrusion 21a of a negative electrode 2a of Example 2. FIG. 4B is an oblique view schematically showing a configuration of a silicon oxide particulate body 26a in the negative electrode 2a of Example 2. The current collector used in this example was a copper foil in which the protrusions 21a were formed on both surfaces thereof and each had a top surface 22a whose plane shape was a regular square (length of one side: 10 μm) as shown in FIG. 4A. The height of the protrusions 21a was set to 5 μm, the clearance between the protrusions 21a adjacent to each other was set to 60 μm, and the thickness d of the current collector was set to 18 μm. The negative electrode 2a was produced in the same manner as in Example 1, except that this current collector was used in place of the current collector 20.

The negative electrode 2a was observed under a scanning electron microscope, and the result found that a silicon oxide particulate body 26a was formed on the surface of each protrusion 21a of the current collector. The silicon oxide particulate body 26a was an aggregate of a plurality of scale-like clusters 27a as shown in FIG. 4B. The silicon oxide particulate body 26a had a spherical three-dimensional shape, and was 15 μm in height and 15 μm in width.

### Example 3

FIG. 5A is an oblique view schematically showing a configuration of a protrusion 21b of a negative electrode 2b of Example 3. FIG. 5B is an oblique view schematically showing a configuration of a silicon oxide particulate body 26b in the negative electrode 2b of Example 3. The current collector used in this example was a copper foil in which the protrusions 21b were formed on both surfaces thereof and each had a top surface 22b whose plane shape was an ellipsoid (major diameter: 15 μm, minor diameter: 10 μm) as shown in FIG. 5A. The height of the protrusions 21b was set to 5 μm, the clearance between the protrusions 21b adjacent to each other was set to 60 μm, and the thickness d of the current collector was set to 18 μm. The negative electrode 2b was produced in the same manner as in Example 1, except that this current collector was used in place of the current collector 20.

The negative electrode 2b was observed under a scanning electron microscope, and the result found that a silicon oxide particulate body 26b was formed on the surface of each protrusion 21b of the current collector. The silicon oxide particulate body 26b was an aggregate of a plurality of scale-like clusters 27b as shown in FIG. 5B. The silicon oxide particulate body 26b had a unidirectionally long spherical (egg-like) three-dimensional shape, and was 15 μm in height and 25 μm in longitudinal width.

### Example 4

FIG. 6A is an oblique view schematically showing a configuration of a protrusion 21c of a negative electrode 2c of Example 4. FIG. 6B is an oblique view schematically showing a configuration of a silicon oxide particulate body 26c in the negative electrode 2c of Example 4. The current collector used in this example was a copper foil in which the protrusions 21c were formed on both surfaces thereof and each had a top surface 22c whose plane shape was a rhomboid (length of long diagonal: 15 μm, length of short diagonal: 10 μm) as shown in FIG. 6A. The height of the protrusions 21c was set to 5 μm, the clearance between the protrusions 21c adjacent to each other was set to 60 μm, and the thickness d of the current collector was set to 18 μm. The negative electrode 2c was produced in the same manner as in Example 1, except that this current collector was used in place of the current collector 20.

The negative electrode 2c was observed under a scanning electron microscope, and the result found that a silicon oxide particulate body 26c was formed on the surface of each protrusion 21c of the current collector. The silicon oxide particulate body 26c was an aggregate of a plurality of scale-like clusters 27c as shown in FIG. 6B. The silicon oxide particulate body 26c had a unidirectionally long spherical (egg-like) three-dimensional shape, and was 15 μm in height and 25 μm in longitudinal width.

### Example 5

FIG. 7A is an oblique view schematically showing a configuration of a protrusion 21d of a negative electrode 2d of Example 5. FIG. 7B is an oblique view schematically showing a configuration of a silicon oxide particulate body 26d in the negative electrode 2d of Example 5. The current collector used in this example was a copper foil in which the protrusions 21d were formed on both surfaces thereof and each had a top surface 22d whose plane shape was a rectangle (long side: 15 μm, short side: 10 μm) as shown in FIG. 7A. The height of the protrusions 21d was set to 5 μm, the clearance between the protrusions 21d adjacent to each other was set to 60 μm, and the thickness d of the current collector was set to 18 μm. The negative electrode 2d was produced in the same manner as in Example 1, except that this current collector was used in place of the current collector 20.

The negative electrode 2d was observed under a scanning electron microscope, and the result found that a silicon oxide particulate body 26d was formed on the surface of each protrusion 21d of the current collector. The silicon oxide particulate body 26d was an aggregate of a plurality of scale-like clusters 27d as shown in FIG. 7B. The silicon oxide particulate body 26d had a unidirectionally long spherical (egg-like) three-dimensional shape, and was 15 μm in height and 25 μm in longitudinal width.

### Comparative Example 1

A negative electrode was produced in the same manner as in Example 1, except that in the formation of an active material layer composed of a plurality of silicon oxide particulate bodies, the degree of vacuum in the vacuum chamber 51 during vapor deposition was set to 1×10⁻⁵ Pa, and the distances from the center point A to the center point B1 and to the center point B2 were respectively set to 5 cm. The obtained negative electrode was observed under a scanning electron microscope, and the result found that a silicon oxide particulate body was formed on the surface of each protrusion 21 of the current collector 20. The silicon oxide particulate body had a columnar three-dimensional shape, and was a solid particulate matter extending in the direction approximately perpendicular to the surface of the current collector. The silicon oxide particulate body was 15 μm in height and 15 μm in width.

Using each of the negative electrodes obtained in Examples 1 to 5 and Comparative Example 1, a cylindrical lithium ion secondary battery as shown in FIG. 1 was fabricated in the manner as described below.

### (1) Production of Positive Electrode

Lithium cobalt oxide powder (LiCoO₂, positive electrode active material) having an average particle size of 5 μm, carbon black (conductive material) and polyvinylidene fluoride (binder) were mixed in a mass ratio of 92:3:5. The resultant mixture was mixed with N-methyl-2-pyrrolidone (dispersion medium), to prepare a positive electrode material mixture slurry. The positive electrode material mixture slurry was applied onto both surfaces of a 15-μm-thick aluminum foil (positive electrode current collector), and the resultant applied film was dried and rolled. A positive electrode was thus produced.

### (2) Preparation of Non-Aqueous Electrolyte

LiPF₆ was dissolved at a concentration of 1 mol/L in a mixed solvent of ethylene carbonate and diethyl carbonate in a volume ratio of 1:1, to prepare a non-aqueous electrolyte.

### (3) Assembling of Battery

Each of the negative electrodes obtained in Examples 1 to 5 and Comparative Example 1 and the positive electrode obtained in the above were spirally wound with a separator (porous insulating layer) made of polyethylene interposed therebetween, to form an electrode group. One end of a copper lead was welded to the copper foil of the negative electrode, and one end of an aluminum lead was welded to the aluminum foil of the positive electrode. An insulating plate made of polypropylene was placed on both longitudinal ends of the electrode group, the other end of the copper lead was welded to the inner side of the bottom of a bottomed cylindrical battery case made of iron, and the electrode group was inserted into the battery case. The other end of the aluminum lead was welded to a sealing plate made of stainless steel.

A predetermined amount of the non-aqueous electrolyte was injected into the battery case. The sealing plate with a polypropylene gasket attached at its periphery was placed at the opening of the battery case, and the opening end of the battery case was crimped onto the sealing plate, to seal the battery case. In such a manner, cylindrical lithium ion secondary batteries including the negative electrodes of Examples 1 to 5 and Comparative Example 1 were fabricated.

### (4) Evaluation

### [Cycle Characteristics Evaluation]

With respect to the lithium ion secondary batteries obtained in the above, the cycle characteristics were evaluated. Each battery was subjected to 200 charge/discharge cycles in an environment of 25° C., each cycle consisting of a constant-current charge and a subsequent constant-current discharge under the conditions below. The discharge capacities at the 1st cycle and the 200th cycle were measured, and the ratio of the discharge capacity at the 200th cycle to that at the 1st cycle was calculated as a percentage, which was referred to as a capacity retention rate (%). The results are shown in Table 1.

Conditions of constant-current charge: constant current density 1 mA/cm², charge cut-off voltage 4.2 V

Conditions of constant-current discharge: constant current density 1 mA/cm², discharge cut-off voltage 2.5 V

### [Evaluation Regarding Silicon Oxide Particulate Bodies]

After having been subjected to 200 charge/discharge cycles in the above cycle characteristics evaluation, each battery was disassembled, and the negative electrode was observed under a scanning electron microscope. The number of silicon oxide particulate bodies separated from the protrusion was counted per 100 protrusions. The results are shown in Table 1.

TABLE 1

| | | Number of separated |
|---|---|---|
| | | silicon oxide |
| Negative | Capacity retention rate | particulate bodies |
| electrode | (%) | (per 100 protrusions) |
| Example 1 | 92 | 0 |
| Example 2 | 89 | 0 |
| Example 3 | 93 | 0 |
| Example 4 | 91 | 0 |
| Example 5 | 88 | 0 |
| Comparative | 75 | 10 |
| Example 1 | | |

Table 1 shows that in the batteries of Examples 1 to 5, the capacity retention rates were considerably higher than that of the battery of Comparative Example 1, and the separation of the silicon oxide particulate body from the protrusion was prevented. This is presumably because: the silicon oxide particulate bodies in Examples 1 to 5 were each an aggregate of a plurality of clusters of silicon oxide; the clusters were spaced apart from each other; and there were large gaps between the silicon oxide particulate bodies adjacent to each other. Presumably as a result, even when the clusters were expanded by absorbing lithium ions, the stress generated in association with the expansion was sufficiently reduced.

Further, the silicon oxide particulate bodies of Examples 1 to 5 had a spherical three-dimensional shape, and therefore, the stress generated due to absorption of lithium ions became uniform in the particulate body. Presumably, this also contributed to prevent the separation of the silicon oxide particulate body from the protrusion.

In contrast, the silicon oxide particulate bodies of Comparative Example 1 were each a solid columnar particle extending in the direction approximately perpendicular to the surface of the current collector, and had no space therein. Further, the silicon oxide particulate bodies were not spherical. Presumably because of this, the stress generated in the silicon oxide particulate body became non-uniform, and the stress concentrated at the interface between the silicon oxide particulate body and the protrusion, causing the silicon oxide particulate body to be easily separated from the protrusion.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The non-aqueous electrolyte secondary battery including the negative electrode of the present invention has excellent cycle characteristics, can be used for applications similar to those of the conventional non-aqueous electrolyte secondary batteries, and is particularly useful as a main power source or an auxiliary power source for, for example, electronic equipment, electric equipment, audio-visual equipment, machining equipment, transportation equipment, and power storage equipment. Examples of the electronic equipment include personal computers, cellular phones, mobile devices, personal digital assistants, and portable game machines. Examples of the electric equipment include vacuum cleaners. Examples of the audio-visual equipment include video recorders and memory audio players. Examples of the machining equipment include electric powered tools and robots. Examples of the transportation equipment include electric vehicles, hybrid electric vehicles, plug-in HEVs, and fuel cell-powered vehicles. Examples of the power storage equipment include uninterrupted power supplies.

1. A negative electrode for a non-aqueous electrolyte secondary battery, the negative electrode comprising: a current collector having a plurality of protrusions on a surface thereof; and particulate bodies being respectively supported on the protrusions, and including an alloy-type active material, said negative electrode having gaps between the particulate bodies adjacent to each other, wherein
the particulate bodies extend outwardly from surfaces of the protrusions of the current collector, and each comprise an aggregate of a plurality of clusters including the alloy-type active material,
the clusters have a scale-like three-dimensional shape, and spaced apart from each other, and
the protrusions have a top surface substantially parallel to the surface of the current collector, and the top surface has minute roughness.

2-4. (canceled)

5. The negative electrode for a non-aqueous electrolyte secondary battery in accordance with claim 1, wherein a plane shape of the top surface is circular, oval, regular square, rectangular, or rhomboid.

6. The negative electrode for a non-aqueous electrolyte secondary battery in accordance with claim 1, wherein a three-dimensional shape of the particulate bodies is spherical, spheroid, or egg-like.

7. The negative electrode for a non-aqueous electrolyte secondary battery in accordance with claim 1, wherein the alloy-type active material is at least one selected from the group consisting of a silicon-based active material, and a tin-based active material.

8. A non-aqueous electrolyte secondary battery comprising a positive electrode absorbing and releasing lithium, the negative electrode for a non-aqueous electrolyte secondary battery of claim 1, a porous insulating layer interposed between the positive electrode and the negative electrode, and a non-aqueous electrolyte with lithium ion conductivity.

9. A method for producing a negative electrode for a non-aqueous electrolyte secondary battery, the method comprising the steps of:
preparing a current collector having a plurality of protrusions on a surface thereof, the protrusions having a top surface substantially parallel to the surface of the current collector, and the top surface having minute roughness; and
forming particulate bodies by vapor deposition in a vacuum of 5×10⁻⁴ Pa to 5×10⁻¹ Pa, the particulate bodies being respectively supported on the protrusions and including an alloy-type active material, wherein
the vapor deposition allows to vaporize a raw material of the alloy-type active material placed on a target at a distance of 10 cm to 500 cm from the current collector, thereby to form the particulate bodies each comprising an aggregate of a plurality of clusters extending outwardly from surfaces of the protrusions of the current collector, having a scale-like three-dimensional shape, and being spaced apart from each other.

10. The method for producing a negative electrode for a non-aqueous electrolyte secondary battery in accordance with claim 9, wherein the vapor deposition is performed in a vacuum of 1×10⁻³ Pa to 1×10⁻² Pa.

11. The method for producing a negative electrode for a non-aqueous electrolyte secondary battery in accordance with claim 9, wherein the target is at a distance of 20 cm to 200 cm from the current collector.

12. The method for producing a negative electrode for a non-aqueous electrolyte secondary battery in accordance with claim 9, wherein the raw material of the alloy-type active material is allowed to be incident on the surface of the current collector at an oblique angle with respect to a direction perpendicular to the surface of the current collector.
